(19) United States
(12) Patent Application Publication
(10) Pub. No.: US 2002/0079255 A1
(43) Pub. Date: Jun. 27, 2002

(54) Folder device, delivery point package and method of use

(76) Inventor: Lance E. Anderson, Stillwater, MN (US)

Correspondence Address: John F. Klos, Esq., Fulbright & Jaworski L.L.P., Suite 4850, 225 South Sixth Street, Minneapolis, MN, 55402-4320, US

(21) Appl. No.: 10/004,595

(22) Filed: Dec. 5, 2001

Related U.S. Application Data
(60) Provisional application No. 60/251,363, filed on Dec. 5, 2000.

(51) Int. Cl. B07C 7/04

(52) U.S. Cl. 209/703; 209/630; 209/900; 209/942

(57) ABSTRACT

The present invention relates to a folder device and method of use in conjunction with a sorting device. The sorting device for use with the folder device may assume a variety of configurations. The present invention provides a folder device for receiving items for use with a sorting device. In one embodiment a first side of the folder is configured in relation to the leading edge of its associated partition element so that at least a portion of the first side does not extend vertically past the leading edge. The present invention further provides a method of creating a delivery point package. The delivery point package may facilitate the delivery of mail items by providing a discrete package by capturing items between the folder sides.

### RELATED APPLICATION

This applications claims the benefit of priority pursuant to 35 U.S.C. §119 of copending Provisional Patent application Serial No. 60/251,363, filed Dec. 2000.

### FIELD OF THE INVENTION

The present invention is directed to a folder for use in conjunction with a device for sorting documents, and more particularly directed to a sorting folder for use with a sorting device such as disclosed in WO 98/20462, now U.S. Pat. No.______ Additionally, the present invention is directed to a folder and method of use for delivery point packaging of mail in an automated or manual mail sorting and delivery operation.

### BACKGROUND OF THE INVENTION

Devices for sorting documents, such as mail and the like, are known. Sorting devices may be manual devices by which a sorter places documents in corresponding slots or other document sorting structures. Additionally, automated sorting devices are known wherein the sorting process is handled under computer or electronic controller direction. In an automated process, information associated with the individual item is read via an optical or magnetic means and utilized to control the ultimate destination of the item in a sorted order. A need exists for a device and method of use for efficiently capturing sorted mail associated with a predetermined address for delivery, i.e., a bundle or delivery point package.

One manual sorting device is disclosed in WO 98/20462, now U.S. Pat. No. ______ , issued to Soderstrom, and incorporated by reference herein. The Soderstrom device relates to sorting documents, mail and the like, which device is designed for arranging the documents in a bundle with a desired order between the documents. In post offices, in mail departments of companies, institutions, government agencies and the like, there is a need for a efficient approach to handling large quantities of mail. The Soderstrom device addresses a need for efficient processing items of mail or other documents so that the items may be distributed to the addressee in a labor-saving way. However, the Soderstrom device is not without limitations. For example, relatively light items placed within the partitions of the device may in some circumstances be separated from associated mail during a controlled fall process. In this regard, the separated items need to be manually reinserted in correct association with the sorted mail. Additionally, it would be desirable to efficiently capture sorted items into a delivery point package for subsequent delivery.

### SUMMARY OF THE INVENTION

The present invention relates to a folder device for use in conjunction with a sorting device. The sorting device for use with the folder device may assume a variety of configurations. In one embodiment, the sorting device may be the Soderstrom device of WO 98/20462, now U.S. Pat. ______. A sorting process with alternative sorting devices may also benefit from aspects of the present invention.

An object of the present invention is the provision of a folder device for receiving items for use with a sorting device. In one preferred embodiment, each side of the folder is associated with one of the partition elements of the sorting device. A first side of the folder is configured in relation to the leading edge of its associated partition element so that at least a portion of the first side does not extend vertically past the leading edge. At least a portion of the second side extends vertically past the leading edge of its associated partition element to facilitate an improved document sorting process.

The present invention is further related to a method of creating a delivery point package through a folder device. The delivery point package may facilitate the delivery of mail items by providing a discrete package by capturing items between the folder sides. The method includes the steps of: sorting a plurality of mail items into mail item subgroupings, each subgrouping including similar destination indicia; providing a plurality of invertable folder devices each having a pair of sides and defining at least a pair of orientations, including a first orientation wherein the sides are generally coextensive with each other; placing between each subgrouping a folder device in a first orientation, accessing a particular subgrouping of mail items and an associated folder device; and inverting the folder device to capture the subgrouping of mail items between the sides of the inverted folder device to define a delivery point package.

### BRIEF DESCRIPTION OF THE DRAWINGS

FIG. 1 is a diagrammatical top view of a first embodiment of the sorting device.

FIG. 2 is a diagrammatical top view of a second embodiment of the sorting device.

FIG. 3 is a diagrammatical sectional view of the first embodiment in FIG. 1.

FIG. 4 is a perspective view of one embodiment of a folder device according to the present invention.

FIG. 5 is a perspective view of the folder of FIG. 4 situated in context with a sorting device.

FIG. 6 is a perspective view of the folder of FIG. 4 situated in context with a sorting device.

FIG. 7 is a diagrammatic view illustrating a method of use of an embodiment of the folder device according to the present invention.

FIG. 8 is a diagrammatic view illustrating an array of sorted items including USPS “flats” and folder devices.

FIG. 9 is a diagrammatic view illustrating an inversion process of a folder device.

FIG. 10 is a diagrammatic view illustrating the array of sorted items of FIG. 8 disposed within a sorting device.

FIG. 11 is a diagrammatic view illustrating a delivery point package according to the present invention.

### DETAILED DESCRIPTION OF THE PREFERRED EMBODIMENTS

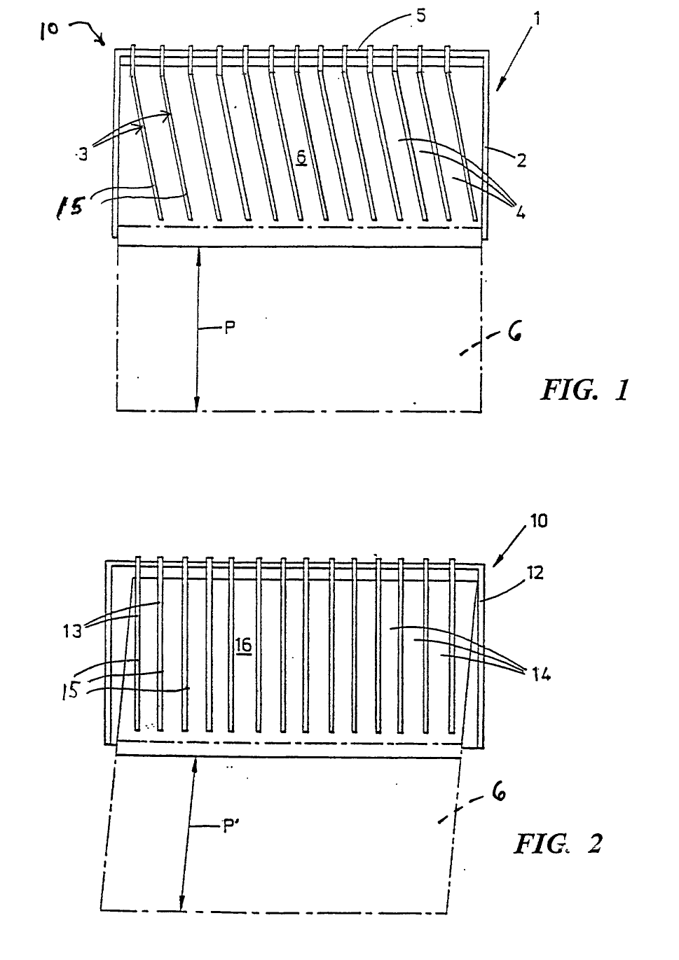

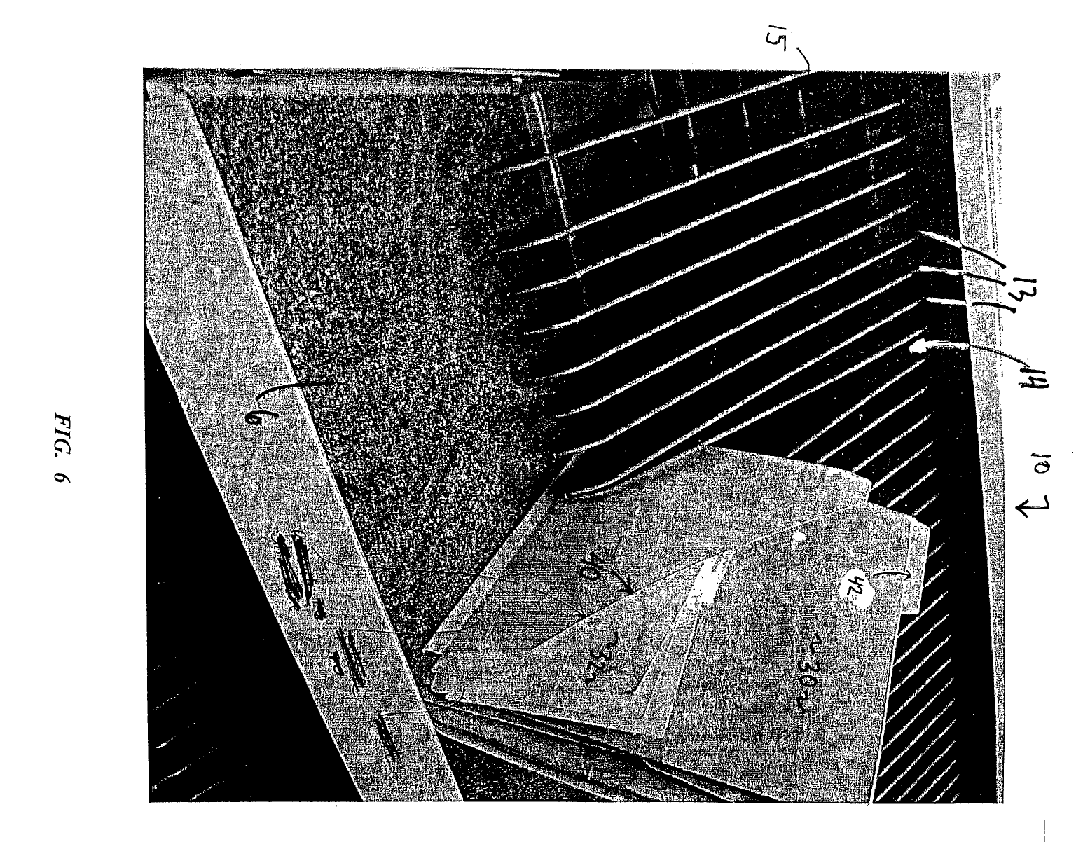

Conventional sorting cabinets for items of documents or mail comprise compartments for sorting the items in a certain order of distribution, e.g. street address or room number. The items are sorted into the compartments, and are then removed and gathered in bundles for distribution within, for example, a postal district. The Soderstrom device 10 aims at providing a sorting device which facilities the bundling of the sorted items by providing means for emptying the sorting compartments in such a way as to automatically bundle the items in sorted order. FIG. 1 shows, in a top plan view, an embodiment of the Soderstrom device 10 for sorting items 1 comprising a frame 2, in which partitions 3 are arranged in a spaced relationship, forming a number of compartments or sorting compartments 4. The partitions 3 are fixedly or removably arranged on the rear section or rear element 5 connected to the frame 2, the partitions extend substantially parallel with respect to each other. In the embodiment shown in FIG. 1, the partitions are bent so that, in a horizontal plane, they will extend in an oblique direction with respect to the frame 2. Extending below the partitions 13, spaced apart from their lower edges, is a horizontal plate member which forms the bottom 6 of the sorting compartments 4. The bottom member 6 is withdrawable from the frame in the direction of arrow P, and displacable with respect to the partitions 3 in a direction P which deviates from the direction in which said partitions extend. The dot-dash line shows the bottom member in a withdrawn or displaced position. Slidable guide means, e.g. guide rails, not illustrated, are arranged in the frame to act as bearing means to allow for the displacement of the bottom member 6. FIG. 6 illustrates the bottom member 6 partially withdrawn from the frame 2. In another embodiment (not shown), the partitions 13 are movably supported upon the frame 2 and are displaceable relative to a stationary bottom 16. In that embodiment, the partitions 13 are extended away from the stationary bottom 16 during the controlled felling operation.

FIG. 2 shows, in a view similar to that of FIG. 1, another embodiment of the Soderstrom device 10 for sorting items. The device 10 has straight partitions 13 extending mainly at right angles in relation to the frame 12, and which run parallel with respect to each other, thus forming a number of sorting compartments 14. The partitions 13 include a leading edge 15, which in this embodiment is a generally linear shape. Alternative leading edge 15 configurations would also be practicable. The partitions 13 are arranged in the frame 12 by suitable means as described above. The bottom 16 of the sorting compartments is arranged on slidable guiding means (not shown) extending obliquely with respect to the frame 10, in order to be displaced in a direction P which deviates from the general direction in which the partitions 13 extend. The dot-dash line indicates the bottom 16 withdrawn from the frame.

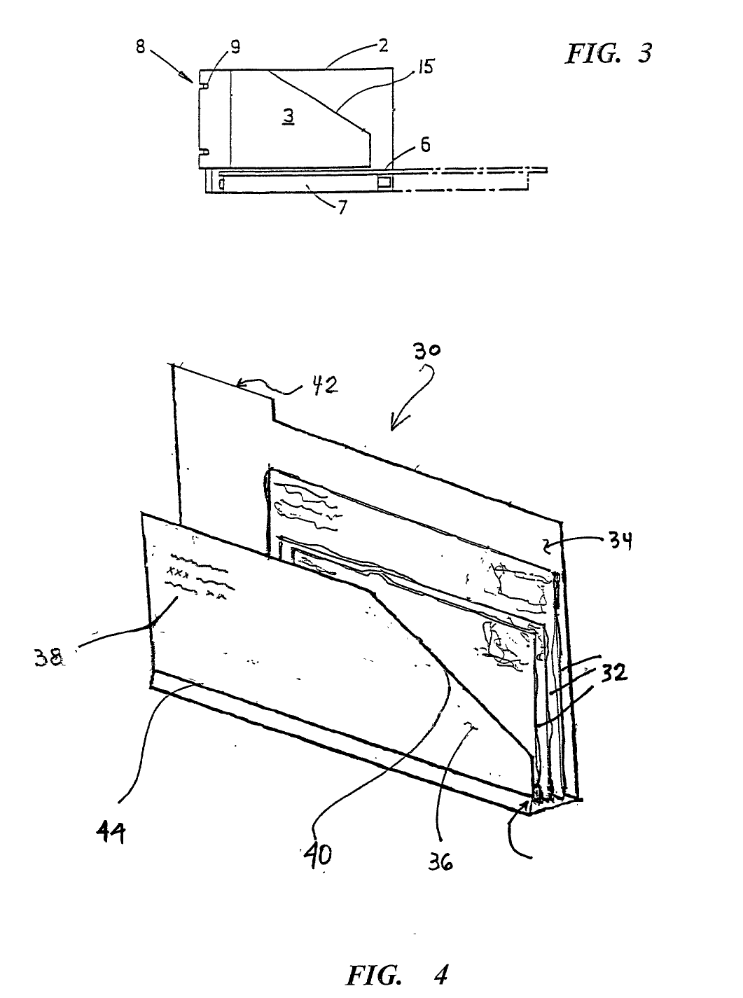

FIG. 3 shows the first embodiment in a diagrammatical cross sectional view with one of the sides of the frame broken away in order to illustrate the displaceable arrangement of the bottom member 6 on slidable guiding means 7, which guiding means are arranged at the lower edge of the side of the frame.

When documents, letters or the like are to be sorted, these are placed in the respective compartment, in accordance with the order in which they are to be distributed, in such a way that the lower edge of each item rest on the displaceable bottom 6 of the compartment. Due to the fact that the bottom of the sorting device is displaceable in relation to the partitions, in a direction which deviates from the general direction in which said partitions extend, the items during the displacing movement of the bottom fall in a controlled manner in the same direction. After the controlled fall, the items may be pushed together into bundles in correct order in an easy manner. Several embodiments of the Soderstrom device are disclosed, which all share the common feature of mutual displacability of the bottom and the partitions in a direction which deviates from the general direction in which the partitions extend, through which displacing movement is achieved the controlled felling of the sorted items in a common direction.

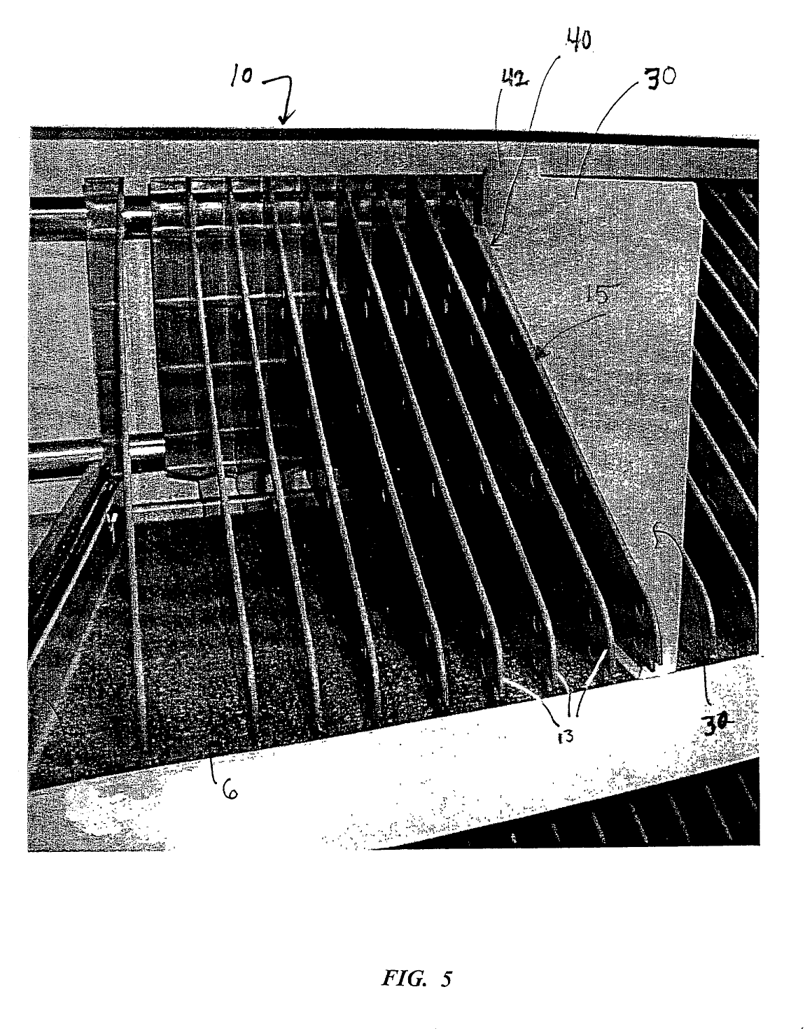

FIGS. 4 through 6 illustrate a folder 30 for use with the sorting device 10. The folder 30 is placed within a sorting compartment 14 for receiving the sorted items 32, such as mail. In one envisioned use, the folder 30 may be used in association with a particular address or location upon the sorting device 10 (defined between a pair of partitions 13) and receive the items 32 destined for that address. While only a single folder 30 is illustrated in FIGS. 5 and 6 in context with the sorting device 10, more than one folder 30 may be utilized in a sorting process. For a typical mail hold operation, relatively few folders 30 would be utilized. After the controlled felling operation, the one or more folders 30 may be removed from the sorted stack of mail for holding and subsequent delivery or redirection.

In another envisioned use, a folder 30 may be used within each of the sorting compartments 14 and used to separate the items 32 from adjacent compartments 14. In this manner, the folders 30 may provide discrete mail packets associated with each of the address locations. Yet another benefit of the folder 30 used in conjunction with the Soderstrom sorting device 10 is the facilitation of sorted document removal from between the partitions 13. Without use of the folder 30, and particularly with substantially full sorting compartments, some light documents may be suspended away from the drawer 6 and be frictionally held by the partition 13 walls as the drawer 6 is extended and be separated from the associated mail items. As an additional step, these separated items then need to be manually replaced within the sorted order of items. By placing a folder 30 in the compartment(s) 14 prior to the sorting process, items 32 can be inserted and held within the folder 30.

Referring particularly to FIG. 4, in one preferred embodiment the folder 30 includes a configured sheet element 34. Sheet element 34 includes an exterior surface 36 suitable for receiving advertising or other indicia 38. Additional indicia 38 may be included upon the interior surface of the sheet element 36. The indicia 38 may include an addressee label or portion for receiving addressee information. In one embodiment, the individual sheet elements 34 may be pre-printed with addressee information, stamped, and delivered as postage-paid mail by the carrier to the addressee. Sheet element 34 may include one or more transparent panels for revealing interior information. Sheet element 34 may include color coding or other color indicia for identifying particular routing information or address status (mail hold, redirect, etc.). Sheet element 34 further includes a side reveal structure 40 which assists in the placement of mail with the folder 30 during a sorting operation. The side reveal structure 40 is shaped in relation to the leading edge 15 of the partitions 13 so that at least a portion of the folder side does not extend vertically above the leading edge 15 of the partition 13. In the illustrated embodiment, the side reveal structure 40 is generally aligned with the leading edge 15 of the partitions 13 when placed in a sorting orientation in the sorting device 10 (See, FIG. 5). The mail carrier or other document handler is able to efficiently place mail into the folder 30 with a left-to-right hand motion passing over the reveal structure 40 and brought into contact with the opposite side wall of the sheet element 34 at which point the mail is released into the associated folder 30. As illustrated in FIGS. 5 and 6, the side reveal structure 40 is configured in relation to the angled front edge 15 of the partitions 13. The sheet element 34 also includes an upper tab element 42 for facilitating the identification of the folder 30 within the stack of sorted items 32.

Yet another feature of the folder 30 is a splay structure 44 which functions to retain the folder 30 in an open manner when placed between the partitions 13 of the sorting device 10. In one embodiment and as illustrated, the splay structure 44 includes a fold line 46 defined upon the folder 30. Alternative splay structures 44 may include multiple fold lines or additional laminates of material disposed proximate the bottom portion of the folder 30. Yet another possible splay structure 44 may include one or more fold lines defined upon one side of the folder 30, with the folder 30 later inverted so that the fold line(s) bias the folder 30 opened. The folder 30 may be provided in a flat, stacked manner and inverted just prior to inserting the folder 30 into the individual sorting compartments 14. Those skilled in the relevant arts may appreciate alternative splay structures to cause the side walls of the folder 30 to diverge.

Referring now to FIG. 7, another aspect of the present invention is disclosed. In this embodiment, the folders 30 may be utilized as dividers within a mail sorting process and to create a delivery point package 50. The uppermost illustration of FIG. 7 represents a mail grouping which has been sorted, such as via a manual or automated process. Subgroupings of sorted items 32 are depicted as numeral 52. Items 32 within the subgroupings 52 are associated with a particular addressee or destination. Folder dividers 30 are provided within the subgroupings 52 of items 32, such that the dividers 30 are adjacent two different subgroupings 52. For example, the dividers 30 are disposed between two different addressees of sorted mail. The dividers 30 may have been processed via an automated sorting process or have been otherwise placed between the subgroupings 52 of mail. In one embodiment of the present invention, the dividers 30 are postage paid mailing items which are processed as regular mail items. In yet another embodiment, the dividers 30 include address specific information 38 and are sorted with reference to the information, but not otherwise being a postage carrying item. In the uppermost illustration of FIG. 7, each of the dividers 30 is placed in a predetermined relationship relative to the balance of the mail subgrouping 52, i.e., the dividers 30 are disposed adjacent the right-most mail item 32 of the subgrouping. Alternatively, the dividers 30 may be disposed adjacent the left-most mail item 32 of the subgroupings 52.

As presented in the intermediate illustration of FIG. 7, the dividers 30 may be inverted to capture mail items 32 within the associated subgrouping 52. The inversion process may be a manual process by a mail sorter, or may be via an automated process. In a manual process, each subgrouping 52 of mail 32 is withdrawn from the sorting device 10 and the folder 30 is inverted around the subgrouping 52 to partially encompass the mail items 32.

As presented in lower illustration FIG. 7, the process of divider 30 inversion captures the associated mail 32 and produces a delivery point package 50. The delivery point package 50 provides an efficient and effective mail item capture device which facilitates the delivery process by potentially decreasing the mail sorting process and reducing the possibility of lost or separated mail items. In one embodiment, information 38 related to the associated mail may be printed on the surface of the inverted folder 30 to facilitate subsequent delivery of the delivery point package 52.

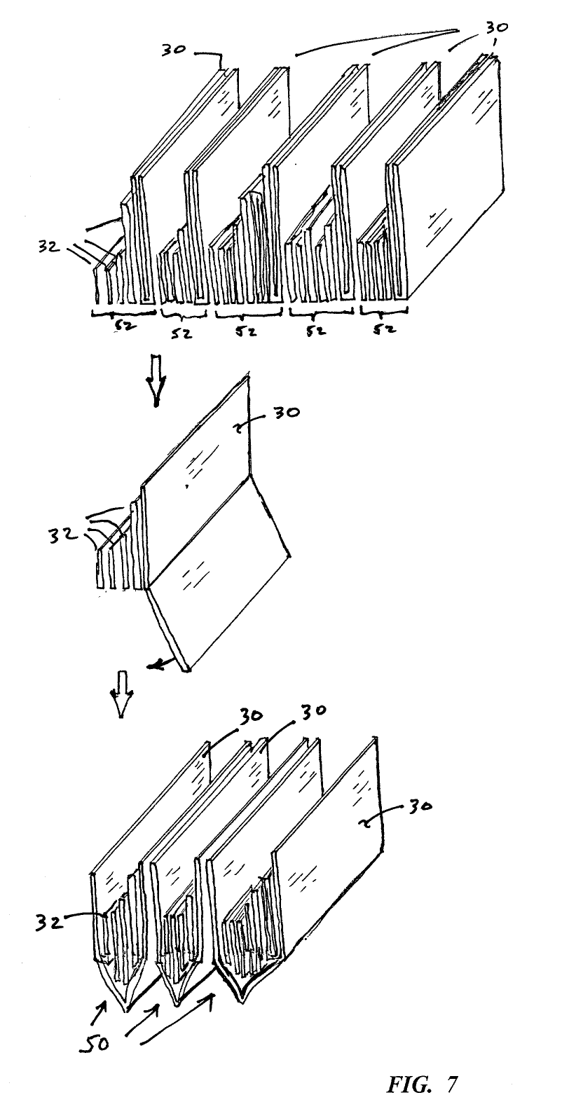

Referring now to FIGS. 8-11, another aspect of the present invention is disclosed. In this alternative embodiment, a hybrid automated / manual sorting process is envisioned. Particular application of this embodiment may include use within the United States Postal Service process, or other partially automated mail sorting systems. The USPS utilizes or is developing automated processes for delivery point sequencing two categories of items; typical letter-sized items and larger mail items, commonly referred to as “flats”. The sorting processes for the two categories are achieved via two different automated sorting systems.

In the embodiment of FIGS. 8-11, the folders 30 may be utilized as dividers within a mail sorting process and to create a delivery point package 50. The mail sorting process may handle different categories of mail items differently, e.g., larger items may be sorted separately from smaller items, etc. FIG. 8 represents larger-sized mail items 60 such as magazines, etc., commonly referred to as “flats” and folders 30 which have been sorted, such as via an automated process. Subgroupings of sorted items 60 and folders 30 are depicted as numerals 62, 64, 66, 68, 70, 72, 74, 76, and 78. Items 60 within the subgroupings 62, 64, 66, 68, 70, 72, 74, 76, and 78 and the folders 30 themselves are associated with a particular addressee or destination. As illustrated, some of the folders 30 will not have any associated “flats” but are otherwise placed in a sorted order via the automated “flats” sorting process. In one embodiment of the present invention, the dividers 30 are postage paid mailing items which are processed via the “flats” automated sorting process. In yet another embodiment, the dividers 30 include address specific information 38 and are sorted with reference to the information, but not otherwise being a postage carrying item.

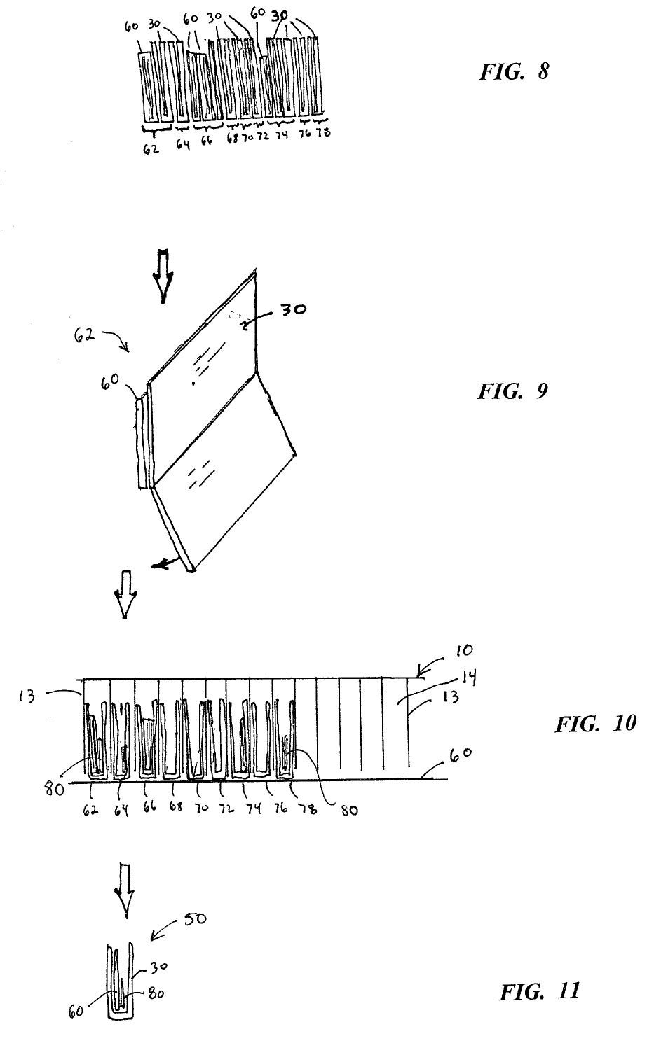

As presented in the illustration of FIG. 9, the dividers 30 may be inverted to capture the “flats” mail items 60 within the associated subgrouping 52. The inversion process may be a manual process by a mail sorter.

As presented in illustration FIG. 10, the inverted dividers 30 may then be placed into a sorting device 10, such as the Soderstrom sorter, at which time additional “non-flats” and other mail items 80 may be inserted into the folder device 10. Upon inserting the additional items 80, including automatically sequenced letter mail (DPS) and “residual mail” (letters and flats which have not been run through automatic delivery point sequencing machines) the inverted dividers 30 holding all mail items 60, 80 can be withdrawn from the sorting device 10. Referring to FIG. 11, the process produces a delivery point package 50 for use as described above.

It will thus be seen that the objects set forth above, among those made apparent from the preceding description, are additionally attained and, since certain changes may be made in carrying out the above process and in the construction set forth without departing from the spirit and scope of the invention, it is intended that all matter contained in the above description and shown in the accompanying drawings shall be interpreted as illustrative and not in a limiting sense. It is also to be understood that the following claims are intended to cover all of the generic and specific features of the invention herein described herein.

I claim:

1. An apparatus of a folder device for use in conjunction with a mail sorting device, said apparatus comprising:
a mail sorting device having a plurality of partition elements supported upon a frame, each of the partition elements having a configured leading edge, a plurality of compartments into which items are placed in a generally upright manner, each of said plurality of compartments being at least partially defined between a pair of partition elements, and a support structure for engaging the items; and
a folder device for receiving items and being generally vertically supported upon the support structure, said folder device having a first side connected to a second side, each side of the folder being associated with one of the partition elements, wherein the first side is configured in relation to the leading edge of its associated partition element so that at least a portion of the first side does not extend vertically past the leading edge, and wherein at least a portion of the second side does extend vertically past the leading edge of its associated partition element.

2. The apparatus of claim 1, wherein the support structure of the sorting device has a first orientation and a second orientation, in the first orientation the support structure supports the items in a generally upright manner, and in the second orientation with the support structure and plurality of partition elements displaced further away from each other the support structure supports the items in a generally horizontal manner

3. The apparatus of claim 1, wherein the folder device includes addressee indicia on a surface thereof.

4. The apparatus of claim 3, wherein the folder device is a postage paid mail item.

5. The apparatus of claim 1, wherein the folder device includes a splay structure which functions to retain the folder device in an open manner when placed between the partitions of the sorting device.

6. The apparatus of claim 1, wherein the folder device includes a generally planar bottom which engages the support structure in the first orientation.

7. An apparatus of a folder device for use in conjunction with a mail sorting device, said apparatus comprising:
a mail sorting device having a plurality of partition elements supported upon a frame, each of the partition elements having a configured leading edge, a plurality of compartments into which items are placed in a generally upright manner, each of said plurality of compartments being at least partially defined between a pair of partition elements, and a support structure for engaging the items; and
a folder device for receiving items, said folder device being generally vertically supported by the support structure between a pair of adjacent partition elements, said folder device having a first side connected to a second side, each side of the folder being associated with one of the partition elements, wherein the first side is configured in relation to the leading edge of its associated partition element so that at least a portion of the first side does not extend vertically past the leading edge, and wherein at least a portion of the second side does extend vertically past the leading edge of its associated partition element.

8. The apparatus of claim 7, wherein the support structure of the sorting device has a first orientation and a second orientation, in the first orientation the support structure supports the items in a generally upright manner, and in the second orientation with the support structure and plurality of partition elements displaced further away from each other the support structure supports the items in a generally horizontal manner

9. The apparatus of claim 7 wherein the folder device includes addressee indicia on a surface thereof.

10. The apparatus of claim 8 wherein the folder device is a postage paid mail item.

11. The apparatus of claim 7 wherein the folder device includes a splay structure which functions to retain the folder device in an open manner when placed between the partitions of the sorting device.

12. The apparatus of claim 7 wherein the folder device includes a generally planar bottom which engages the support structure in the first orientation.

13. A method of creating a delivery point package, said method comprising the steps of:
sorting a plurality of mail items into mail item subgroupings, each subgrouping including similar destination indicia;
providing a plurality of invertable folder devices each having a pair of sides and defining at least a pair of orientations, including a first orientation wherein the sides are generally coextensive with each other;
placing between each subgrouping a folder device in a first orientation, each subgrouping having an associated folder device,
accessing a particular subgrouping of mail items and an associated folder device; and
inverting the folder device to capture the subgrouping of mail items between the sides of the inverted folder device to define a delivery point package.

14. A method of claim 13, wherein at least one of the plurality of invertable folder device has addressee indicia disposed upon a surface thereof.

15. A method of claim 14, wherein the step of placing a folder device between each subgrouping includes the step of referencing the addressee indicia of the folder device.

16. A method of claim 13, wherein the step of inverting the folder device to capture the subgrouping of mail items is achieved via manual manipulation of the folder device.

17. A method of claim 13, wherein the step of inverting the folder device to capture the subgrouping of mail items is achieved via an automated process.

18. A method of creating a delivery point package, said method comprising the steps of:
sorting a plurality of mail items into mail item subgroupings, each subgrouping including similar destination indicia, said mail items including a plurality of invertable folder devices, each folder device having a pair of sides and defining at least a pair of orientations, including a first orientation wherein the sides are generally coextensive with each other;
accessing a subgrouping of mail items and an associated folder device; and
inverting the associated folder device to capture the subgrouping of mail items between the sides of the inverted folder device to define a delivery point package.

19. A method of claim 18, wherein the step of inverting the folder device to capture the subgrouping of mail items is achieved via manual manipulation of the folder device.

20. A method of claim 18, wherein the step of inverting the folder device to capture the subgrouping of mail items is achieved via an automated process.

21. A method of creating delivery point packages for mail delivery, said method comprising the steps of:
sorting a plurality of mail items of a first category according to a unique destination indicia;
associating a folder device with each unique destination indicia;
inverting each folder device to capture mail items associated with a unique destination indicia between sides of the inverted folder device;
placing the inverted folder devices into a sorting machine having a plurality of partition elements;
inserting a plurality of mail items of a second category into the inverted folder devices in the sorting machine according to unique destination indicia; and
removing the inverted folder devices having mail items of the first and second category to define a delivery point package.

22. A method of claim 21, wherein at least one of the plurality of invertable folder device has addressee indicia disposed upon a surface thereof.

23. A method of claim 21, wherein the step of sorting a plurality of mail items of a first category is via an automated sorting process, and wherein the process of inserting a plurality of mail items of a second category is a manual process.

24. A method of claim 21, wherein the step of inverting each folder device to capture associated mail items is achieved via manual manipulation of the folder device.

25. A method of claim 21, wherein the mail items of a first category include USPS designated flats, and wherein the mail items of a second category include USPS designated non-flats.

26. A method of creating a delivery point package, said method comprising the steps of:
sorting a plurality of mail items of a first category according to a unique destination indicia, said mail items including a plurality of invertable folder devices, each folder device having a pair of sides;
inverting the folder devices to capture mail items having a unique destination indicia between the pair of sides;
placing the inverted folder devices into a sorting machine having a plurality of partition elements;
inserting a plurality of mail items of a second category into the inverted folder devices in the sorting machine according to unique destination indicia; and
removing the inverted folder devices having mail items of the first and second category to define a delivery point package.
